(19) United States
(12) Patent Application Publication
(10) Pub. No.: US 2006/0167148 A1
(43) Pub. Date: Jul. 27, 2006

(54) System for a chemically bonded ceramic material, a powdered material and a hydration liquid therefore, the ceramic material, a method for its production and a device

(76) Inventors: Hakan Engqvist, Margaretavagen (SE); Leif Hermansson, Lanna Gard (SE); Jesper Loof, Uppsala (SE); Nils-Otto Ahnfelt, Knivsta (SE)

Correspondence Address: YOUNG & THOMPSON, 745 SOUTH 23RD STREET, 2ND FLOOR, ARLINGTON, VA, 22202, US

(21) Appl. No.: 10/518,083

(22) PCT Filed: Jun. 11, 2003
(86) PCT No.: PCT/SE03/00955

§ 371 Date: Jul. 22, 2005

(30) Foreign Application Priority Data
Jun. 20, 2002 (SE) 0201918-0
Sep. 10, 2002 (SE) 0202696-1

(51) Int. Cl. C09D 5/14

(52) U.S. Cl. 524/200

(57) ABSTRACT

A system for a chemically bonded ceramic material, comprising an aqueous hydration liquid and a powdered material, the binder phase of which essentially consisting of a cement system, which powdered material has the capacity following saturation with the hydration liquid reacting with the binder phase to hydrate to a chemically bonded ceramic material. According to the invention, the powdered material comprises a first part component for the formation of an organic phase in the ceramic material and the hydration liquid comprises a second part component for the formation of said organic phase. The invention also relates to the powdered material and the hydration liquid, respectively, the formed ceramic material, a method for the production of the material and a device for storing the powdered material and mixing it with the hydration liquid.

### TECHNICAL FIELD

The present invention relates to a system for a chemically bonded ceramic material, preferably a dental filling material or an implant material, comprising an aqueous hydration liquid and a powdered material that essentially consists of an inorganic cement system, which powdered material has the capacity following saturation with the hydration liquid to form a complex, chemically bonded material with inorganic as well as organic phases. The invention also relates to the powdered material and the hydration liquid, respectively, the formed ceramic material, a method for the production of the material and a device for storing the powdered material and mixing it with the hydration liquid.

### STATE OF THE ART AND PROBLEM

The present invention relates to binding agent systems of the hydrating cement system type, in particular cement-based systems that comprise chemically bonded ceramics in the group that consists of aluminates, silicates, phosphates, sulphates and combinations thereof, having calcium as the major cation. The invention has been especially developed for biomaterials for dental and orthopaedic applications, both fillers and implants including coatings, but can also be used as fillers in industrial applications in electronics, micro-mechanics etc.

For materials, such as dental filling materials and implants, that are to interact with the human body, it is an advantage that the materials are made as bioactive or biocompatible as possible. Other properties that are required for dental filling materials and implants are a good handling ability with simple applicability in a cavity, moulding that permits good modellability, hardening/solidification that is sufficiently rapid for filling work and provides serviceability directly following therapy, high hardness and strength, corrosion resistance, good bonding between filling material and biological wall, dimensional stability, radio-opacity, good long time properties and good aesthetics especially regarding dental filling materials. For the purpose of providing a material that fulfils at least most of these required properties, a material has been developed according to what is presented in SE 463,493, SE 502,987, WO 00/21489, WO 01/76534 and WO 01/76535, e.g.

### BRIEF ACCOUNT OF THE INVENTION

The present invention specifically relates to the complex of problems of modellability, high strength and viscoelasticity, dimensional stability (avoiding shrinking or excessive expansion) and aesthetics, especially regarding dental filling materials, i.e. the problem of being able to optimise a complex property profile in a product.

Accordingly, the present invention aims at providing a biomaterial having a complex property profile and thereby to provide a powdered material that consists of a cement based system that has the capacity following saturation with a liquid reacting with the powdered material to hydrate and chemically react to a chemically bonded material, which material exhibits both a high degree of compaction, good modellability, minimal dimensional changes upon hardening and good mechanical properties such as a high E-modulus, a certain viscoelasticity and a high strength. Yet another object of the invention is to provide such a material that also exhibits radio-opacity and improved translucency.

These and other objectives are attained by the system, the powdered material, the hydration liquid, the ceramic material and the device according to the invention, as defined in the claims.

A material that has the capacity to by in-situ activation (chemically, thermally and/or photochemically) form an organic phase is added to an inorganic cement material, preferably having Ca-aluminate as its major component. The organic phase should fulfil the following requirements:

1. Non-communicating separate areas or as a network—depending on dimensional requirements on hardening and other optimised properties—at contents below 50% by volume of the material, preferably 5-40% by volume and even more preferred 10-35% by volume and most preferred 15-25% by volume.

2. Good biocompatibility

3. Partial hydrophilicity

4. Capability to plasticize

These and other objectives are attained by the inventive process technique, the powdered material and the hydration liquid and are based on the following unique abilities:
1. Inorganic cement, preferably the Ca-aluminate based system that via its communicating micropore system gives the opportunity to feed in water via moisture, saliva, aqueous solutions that react with Ca— and hydroxyl ions or added ions (phosphate e.g.) and seals the porosity to low levels.
2. Organic phase that by improved elasticity properties gives the material a more ductile behaviour with a lowered risk of stress concentrations on loading.
3. Organic additive that gives an improved modellability in the system.
4. Improved aesthetics by formation of a stabile material that has few defects.
5. The possibility to control activation of reactions by physical separation of activating substances and bringing them together when the reactions are to be activated.

According to a preferred embodiment of the invention, the powdered material exists in the form of granules of powder particles, which granules exhibit a degree of compaction above 55% and a mean size of 30 -250 μm. By using such very highly compacted small granules, the shaping of the material can take place in a subsequent step, without any remaining workability limitations of highly compacted bodies. A facilitated shaping in such a subsequent step, such as kneading, extrusion, tablet throwing, ultrasound etc., can be made while retaining a mobility in the system that has a high final degree of compaction, exceeding 55%, preferably exceeding 60%, even more preferred exceeding 65% and most preferred exceeding 70%.

The principle is based on the fact that a small granule—after granulation of a pre-pressed, highly compacted body—contains several tenths of millions of contact points between particles in the same, which particles are in the micrometer magnitude. When these small granules are pressed together to form new bodies, new contact points arise, which new contact points are not of the same high degree of compaction. The lower degree of compaction in these new contact points results in an improved workability, while the total degree of compaction is only marginally lowered by the lower degree of compaction in the new contact points. This is due to the new contact points only constituting a very slight proportion of the total amount of contact points. Even if for example a thousand new contact points are formed, these contact surfaces will be less than per mille of the total contact surfaces, i.e. they have a very slight influence on the end density, which will be determined by the higher degree of compaction of the granules according to the present invention. Moreover, the contact zones between individual, packed granules will hardly be distinguishable from the other contact points, as the general hardening mechanism for systems according to the invention comprises dissolution of solid material by reaction with water, which leads to the formation of ions, a saturated solution and hydrate precipitation.

In a system in which the cement hydrates due to an added liquid, the new contact points will furthermore be filled by hardened phases, which means that the homogeneity increases after the hydration/hardening. By the final degree of compaction being increased in that way, a more dense end product will be obtained, which leads to an increased strength, a possibility to lower the amount of radio-opaque agents and an easier achieved translucency, at the same time as the workability of the product is very good.

According to one aspect of this embodiment, the granules preferably exhibit a degree of compaction above 60%, even more preferred above 65% and most preferred above 70%. Preferably, the granules have a mean size of at least 30 μm, preferably at least 50 μm and even more preferred at least 70 μm, but 250 μm at the most, preferably 200 μm at the most and even more preferred 150 μm at the most, while the powder particles in the granules have a maximal particle size less than 20 μm, preferably less than 10 μm. It should hereby be noted that it is only a very slight proportion of the powder particles that constitute particles having the maximal particle size. The particle size is measured by laser diffraction. The highly compacted granules are manufactured by the powdered material being compacted to the specified degree of compaction, by cold isostatic pressing, tablet pressing of thin layers, hydro-pulse technique or explosion compacting e.g., where after the material compacted accordingly is granulated, for example crushed or torn to granules of the specified size.

According to another aspect of the invention, the cement-based systems comprises chemically bonded ceramics in the group that consists of aluminates, silicates, phosphates, sulphates and combinations thereof, preferably having cations in the group that consists of Ca, Sr and Ba. The cement may also comprise one or more expansion compensating additives adapted to give the ceramic material dimensionally stable long-term attributes, as is described in WO 00/21489.

It is also conceivable that said powdered material comprises a glass phase that contributes to translucency and that exhibits the capacity following saturation with a liquid reacting with the binder phase to hydrate to a chemically bonded ceramic material.

According to another embodiment, said glass phase may comprise glass ionomer glass, i.e. glasses known for use in glass inonomer cements. As an alternative, or in combination, the powdered material may comprise bioactive or bioresorbable materials.

The powdered material, preferably only in the form of granules including optional additives or possibly granules and non pre-compacted powder material, may, according to yet another embodiment, be mixed with a liquid that reacts with the binder phase, where after the resulting suspension is injected directly into a cavity that is to be filled. Suitably, the liquid comprises water and—in addition to the inventive part component that has the capacity together with a part component in the powdered material to form organic phase—accelerator, disperser and/or superplasticizer, in order to obtain a suitable consistency of the suspension. The accelerator speeds up the hydrating reaction and is preferably composed of a salt of an alkali metal. Most preferably, a lithium salt is used, e.g. lithium chloride, lithium fluoride or lithium carbonate. The superplasticizer is preferably composed of a lignosulphonate and/or citrate, EDTA and/or hydroxycarboxy containing compounds, PEG or substances with PEG-containing units. Also in an embodiment in which the suspension is drained and compacted, the accelerator, disperser and/or superplasticizer may of course be used, as well as in an embodiment in which the material is compacted to a raw compact, in which case the raw compact is brought to absorb the liquid when the ceramic material is to be produced.

The present invention also relates to a system for the production of a chemically bonded ceramic material of a powdered material, the binder phase of which essentially consisting of a calcium based cement system, which system has the capacity to form apatite in-situ. By capacity to form apatite in-situ it is hereby meant that the system comprises the components that are necessary for the formation of apatite, hydroxyapatite or fluoride-apatite ((Ca₅(PO₄)₃OH and Ca₅(PO₄)₃F, respectively) for example, and optionally some other biologically favourable phase, and that the system allows for such phases to be formed during and/or after the hydration reaction.

Additives to the binder phase can also have any morphology or form, including: spheres, regular or irregular forms, fibres, whiskers, plates or the like. Particles of the additives should be smaller than 30 μm, preferably smaller than 10 μm, even more preferred smaller than 5 μm.

Regarding other aspects concerning the method of suspension, reference is made to WO 01/76534, the content of which is incorporated herein by reference. Regarding other aspects of raw compacts, reference is made to WO 01/76535, the content of which is incorporated herein by reference.

In addition to applications such as dental filling materials or orthopaedic compositions, applications within fields such as substrates/casting materials for electronics, micro-mechanics, optics and within biosensor techniques can be seen. The environmental aspects will also give the material a large field of use for yet another application, namely as a putty.

### DETAILED DESCRIPTION OF THE POWDERED MATERIAL

1. The main binder phase of the powdered material consists of a calcium based, basic ceramic powder in the group that consists of aluminates, silicates, phosphates, sulphates and combinations thereof, preferably aluminates.

Effect: By formation of hydrates, a filling up of porosities and other micro-spaces between the filling material and the biological wall or some other contact zone takes place.

2. The material contains at least a first organic part component that has the capacity by reaction with a second organic part component in the hydration liquid to form an organic phase, preferably a polymer (see the more detailed description in the hydration liquid section).

Effect: Organic polymer forming material contributes to an improved workability during the compaction phase and to the obtaining of a certain viscoelasticity in the end product.

3. Preferably, the powdered material contains water soluble phosphate, whereby the cement system has the capacity during the hydration to form apatite.

Effect: additionally increased biocompatibility is obtained.

4. The powdered material may comprise an addition of collagen, elastin or other high-molecular polymers (protein, cellulose, polyester, polyacetal etc.) that are allowed to be formed in-situ.

Effect: fine distribution of organic phase

5. The material may comprise additives of collagen, elastin or other high-molecular polymers that are coated in-situ or are pre-coated by apatite from a saturated solution.

Effect: to control the deposition of apatite. 6. The powdered material may comprise carbonate or biologically existing ions that may form: oxalates, lactates, calcite, aragonite. Carbonate ions may for example form calcite and calcium may form difficultly soluble biological salts with the anion of the lactic acid, lactate etc.

Effect: by controlling the concentration and the composition of the ions, different biological phases containing Ca may be deposited. This also applies to water-soluble additives in the powdered raw material.

It is especially preferred that the main binder phase of the cement system consists of calcium aluminate (Ca-aluminate), since:
1. Ca-aluminates will give a basic local environment for the apatite, which makes that phase stable (no dissolution, preventing formation of plaque and attacks of lactic acid).
2. Ca-aluminate exists in surplus and is formed in all pores in the material—contributes to fill the material—if only apatite was used for example, too little water would be transformed in order for water-filled porosity to be filled by hydrate.

Ca-aluminate is deposited by acid-base reaction, in which water reacts with the powdered material, that starts to dissolve. In the solution, all constituents exist that are needed for the formation of both calcium aluminate hydrate, gibbsite and apatite (if some type of phosphor is supplied) and possibly some other biologically favourable phase (calcite, aragonite, lactate etc.). When the solubility product of each substance is reached, a deposition starts to take place. The deposition takes place everywhere, including inside the micro-spaces between the filling material and the tooth wall. Small crystals are deposited in the surface topography in the tooth wall or some other biological contact surface and contributes to the complete disappearance of the contact zone of filling material-tooth/bone, leading to micro-structural integration.

### DETAILED DESCRIPTION OF THE HYDRATION LIQUID

The hydration liquid is water based and has additives of an organic part component for formation of polymer and preferably additives for reaction control regarding general hydration and formation of polymer, ions for formation of apatite and thickeners.

Organic component: Preferably a component that participates in a co-polymerisation reaction, preferably a condensation polymerisation, in which a resulting formation of water supplies raw material for the general hydration reaction. Accordingly, the co-polymerisation reaction may coexist with an acid-base reaction that is the driving reaction in the hydration of the cement. Another alternative is the utilization of a photo-chemically induced reaction, in which monomers are added to the powdered material while an initiator is added via the hydration liquid or is added separately.

Possible organic components are: monomers of the hydrophilic methacrylate type, HEMA e.g., monomers having phosphate groups, alkenoids, monomers for carbopolymers. The organic additives act analogously with dental filling materials that generally are denoted compomers.

A step by step polymerisation may be used and it is usually based on condensation reactions.

Two different reactive groups react with one another and a smaller molecule, e.g. water or some other molecule, is often split off. The stoichiometric ratio of the two monomers controls the molecular weight and end group functionality.

Example of step by step polymerisation: A diol and a diacid react and form a dimer having two reactive ends. An ester bond has formed between them and a water has been split off. (If the water is continuously led away or consumed (e.g. in a cement reaction according to the present invention), the reaction is urged on and a higher molecular weight of the polymer is attained.) Now, the reactive dimer may react with a new monomer or with another chain of higher molecular weight. Polycarbonates are often prepared by step by step polymerisation. When using diols and diacids or similar, one of the part components is advantageously added to the powdered material and the other to the hydration liquid, preferably diol to the powdered material while diacid is added to the hydration liquid.

An important aspect of the invention is the possibility that is provided via the powdered material to take care of the water that is formed in the condensation polymerisation. This water is used in the hydration reaction. This is central, especially in orthopaedic applications in which intake of water from the surroundings may be limited.

A material according to the present invention could in the case of dental filling materials be described as a compocer, where “cer” is an abbreviation for chemically bonded ceramics.

The term biocer could also generally be used.

General effect: Gives the product a viscoelastic behaviour.

Other additives: A description is clear from the general description and from the above cited patent citations.

### PROCESS TECHNIQUE

By addition of energy (light, heat) a free radical is formed from an added initiator (e.g. dibensoylperoxide). This free radical adds to the monomer and activates the monomer by “transforming” it into a radical. After enough initiation, no more energy needs to be added as the polymerisation continues by radicalised polymer chains reacting with unreacted monomers. The materials are formed by chemical reaction when different parts are mixed or come in contact with each other. These parts consist of powdered material (Pm) and hydration liquid (Hl). Pm may exist in a separate container as a powder, granules or tablets. H1 exists in a separate container provided with a connection with Pm. The connection is broken on use, and the components are quickly mixed by aid of an underpressure in the Pm-part or an overpressure in the Hl-part. Thereafter, the material can be kneaded or vibrated, by ultrasound e.g. In most cases, initiator, terminator and inhibitor may be avoided by keeping Pm and Hl separated before use. Normally, these compounds are the most toxic compounds in polymer preparation. See also FIGS. 1 and 2.

One advantage of the invention is that lower contents of organic additives are required compared to the case of compomers, due to the general properties of the inorganic, powdered, raw material. The low content of organic additive will also, in addition to a pore filling effect in the ceramic material, result in a lowered shrinking effect as compared to the compomer case.

Another aspect of the distribution of organic phase in thin, finely dispersed areas or in networks and the strive and ability in accordance to the invention to maintain the organic part below 50% by volume, is the possibility to the reduce the temperature rise during the reaction, preferably to 50° C. at most and more preferred to 42° C. at most, which is especially important in the use as orthopaedic pastes, in which case larger amounts are often used compared to dental applications.

### EXAMPLE 1

Inorganic Raw Materials: Monocalcium Aluminate, Glass Particles

Hydration Liquid: Water, LiCl

Additivesfor Polymer Formation: Diol and Diacid

Formed Polymer: Condensation Polymer of Carbonate Type.

The examples below describe:
a) The flexural strength and the E-modulus for hydrated monocalcium aluminate having 30% by volume glass particles as a filler.
b) The flexural strength and the E-modulus for hydrated calcium aluminate and 5% by volume polymer in hardened condition having 30% by volume glass particles as filler.
c) The flexural strength and the E-modulus for hydrated calcium aluminate and 10% by volume polymer in hardened condition having 30% by volume glass particles as filler.
d) The flexural strength and the E-modulus for hydrated calcium aluminate and 20% by volume polymer in hardened condition having 30% by volume glass particles as filler. e) The flexural strength and the E-modulus for hydrated calcium aluminate and 40% by volume polymer in hardened condition having 30 % by volume glass particles as filler.

The monocalcium aluminate raw material was ground in a jet stream mill to a particle size of 10 μm at the most. The glass particles have a particle size of 7 μm at the most.

The powdered raw materials in the respective example were dry blended to the appropriate ratio. Also the hydration liquids in the respective example were blended to the appropriate ratio to produce the appropriate amount of polymer at hardening. LiCI (0.1 g/l water) was added to obtain a more rapid hydration process for the calcium aluminate.

By linear pressing at 150 MPa of the powdered raw materials, plates having a height of 2 mm and a diameter of 11 mm were manufactured for flexural strength testing in accordance with ASTM-F394 and cylindrical rods were manufactured for measurement of E-modulus in tensile testing. The plates and the rods were wetted by the respective liquid and were kept in water at 37° C. for 14 days, before measuring properties. All samples were polished to a surface finish of 0.1 μm. The results of the measurements are shown in Table 1.

TABLE 1

| Sample designation | Flexural strength (MPa) | E-modulus (GPa) |
|---|---|---|
| A | 81 | 19 |
| B | 90 | 18.5 |
| C | 104 | 17.9 |
| D | 114 | 16.7 |
| E | 97 | 14.2 |

The results show that a considerable increase of the flexural strength can be obtained at maintained E-modulus for compositions containing cured polymer in combination with hydrated calcium aluminate.

### EXAMPLE 2

Tests were performed in order to study the effect of polymer on translucency and dimensional stability.

Description of Materials

Materials having compositions according to Example 1a and 1d above.

Thin plate test bodies were manufactured analogously with Example 1 for measurement of translucency in accordance with ISO 9917 and for measurement of dimensional stability. The samples for measurement of translucency were kept in water of 37° C. for 14 days before measuring. The dimensional stability was measured as change of size over time for 20 mm rods and the measurements were performed on wet/moist samples.

The results are shown in Table 2.

TABLE 2

| | | Dimensional change after |
|---|---|---|
| Sample designation | Translucency | 90 days (% linear) |
| A | 23 | +0.09 |
| D | 40 | +0.02 |

The results show that an enhanced translucency can be obtained at maintained dimensional stability for materials containing hardened calcium aluminate and polymer, compared to polymer-free calcium aluminate hydrate.

### DRAWINGS DESCRIPTION

FIG. 1 is showing a device according to a first embodiment, for storing the powdered material and for mixing it with the hydration liquid that reacts with the binder phase,

FIG. 2 is showing a device according to a second embodiment, for storing the powdered material and for mixing it with the liquid that reacts with the binder phase.

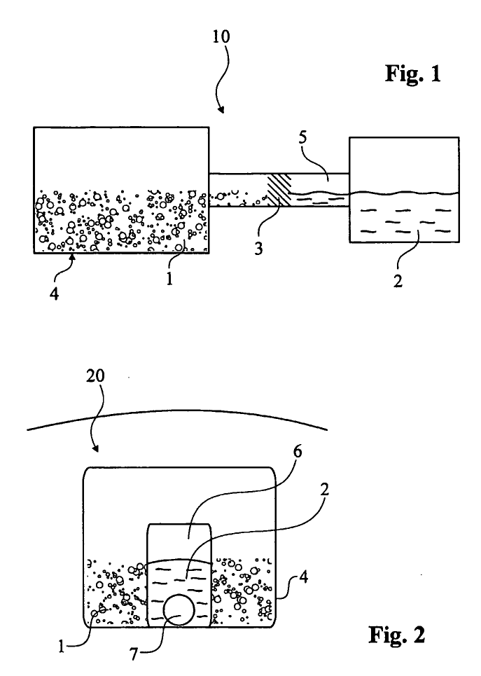

The device 10 in FIG. 1 is adapted to store powdered material according to the invention, here exemplified by powdered material in the form of granules, and the hydration liquid that reacts with the binder phase. More particularly, a given amount of granules are held in a first chamber 1 and an amount of liquid that is adapted to the amount of granules and to the desired W/C ratio is held in a second chamber 2. The size, shape and filing degree of the chambers may vary, the filling degree usually being close to 100%. The chambers 1, 2 are connected to each other by a passage 5, which however is sealed by a seal 3 (a membrane e.g.) at storing. In the first chamber 1 there is preferably a lower pressure than in the second chamber 2. When a chemically bonded ceramic material is to be produced from the granules and the liquid, the seal 3 is broken and the liquid may flow from the second chamber 2 in to the first chamber 1, a possible pressure difference acting as a driving force, or by aid of a squeezing of the second chamber 2 and/or by aid of the gravitation. Accordingly, the supply of liquid takes place in a closed room.

The first chamber 1 at least is designed with walls 4 of a wall material that allows a mechanical processing of the granules/liquid through these walls 4. Suitably, the first chamber 1 is constituted by a flexible bag. Also the second chamber may be formed of the same material, the seal 3 being composed e.g. by a weld between the two chambers. The mechanical processing may for example be kneading, rolling, hand pressing, etc. The material is thereafter transferred to a system that is adapted for the applying.

FIG. 2 shows a second embodiment of a device according to the invention. In the device 20, the second chamber 2 is arranged inside the first chamber 1. The second chamber 2 has walls 6 in the form of or comprising a membrane, and holds a ball 7 (a plastic ball e.g.) in addition to the liquid. By shaking the entire device 20, the membrane is broken by the ball. Here too, a pressure difference preferably exists between chambers 1 and 2. Of course, the device may also be performed such that the first chamber with the granules is arranged inside the second chamber with the liquid. By the shaking and the pressure difference, a mixing of the liquid and the material will take place in any case, to form a paste. Thereafter, the paste is applied by a squirt, in a cavity that is to be filled by the material.

The device according to the invention is especially suitable for storage, distribution and preparation of the material when the material is composed of a dental or orthopaedic material, but can also be used in other applications.

The invention is not restricted to the embodiments detailed above but can be varied within the scope of the claims.

1-32. (canceled)

33. A powdered material, the binder phase of which essentially consists of a cement system, which powdered material has the capacity, following saturation with a hydration liquid, to hydrate to a chemically bonded ceramic material, characterised in that said powdered material comprises a first part component which has the ability, together with a second part component not comprised in said powdered material, to form an organic phase in the form of a polymer selected from the group that consists of polymers based on hydrophilic or partially hydrophilic acrylate, carbonate, protein, cellulose, siloxane, polyacetal, collagen, elastin, polyester.

34. A powdered material according to claim 33, characterised in that the binder phase is a ceramic powder selected from the group that consists of aluminates, silicates, phosphates, sulphates and combinations thereof.

35. A powdered material according to claim 34, characterised in that the binder phase is has cations selected from the group consisting of Ca, Sr and Ba.

36. A powdered material according to claim 35, characterised in that said first part component is a monomer selected from the group that consists of monomers of hydrophilic methacrylate type, HEMA, monomers having phosphate groups, alkenoids, monomers for carbopolymers, diols, diacids.

37. A powdered material according to claim 33, characterised in that it exists in the form of granules of powder particles, which granules exhibit a degree of compaction above 55% and a mean size of 30-250 μm.

38. A powdered material according to claim 37, characterised in that said granules exist in a composition that comprises up to 50% non pre-compacted powdered material, of the same cement-based system as the powdered material in the granules.

39. An aqueous hydration liquid for hydration of a powdered ceramic material according to claim 33 to a chemically bonded ceramic material, characterised in that said hydration liquid comprises a second part component which has the ability, together with a first part component comprised in said powdered material, to form an organic phase in the form of a polymer.

40. A hydration liquid according to claim 39, characterised in that said second part component is a polymer selected from the group that consists of polymers based on hydrophilic or partially hydrophilic acrylate, carbonate, protein, cellulose, siloxane, polyacetal, collagen, elastin, polyester.

41. A hydration liquid according to claim 39, characterised in that said second part component is a monomer selected from the group consisting of monomers of hydrophilic methacrylate type, HEMA, monomers having phosphate groups, alkenoids, monomers for carbopolymers, diols, diacids, amino acids.

42. A hydration liquid according to claim 40, characterised in that said second part component is a monomer selected from the group that consists of diacids or aminoacids.

43. A chemically bonded ceramic material, the binder phase of which essentially consisting of an inorganic cement phase, which ceramic material is in situ-formed on a substrate or in a cavity, characterised in that said material also comprises an situ-formed polymer selected from the group that consists of polymers based on hydrophilic or partially hydrophilic acrylate, carbonate, protein, cellulose, siloxane, polyacetal, collagen, elastin, polyester.

44. A ceramic material according to claim 43, characterised in that its binder phase is a calcium-containing ceramic powder in the group that consists of aluminates, silicates, phosphates, sulphates and combinations thereof.

45. A ceramic material according to claim 43, characterised in that its binder phase has cations selected from the group consisting of Ca, Sr and Ba.

46. A ceramic material according to claim 43, characterised in that the inorganic cement phase constitutes 50% by volume or more of the ceramic material.

47. A ceramic material according to claim 43, characterised in that the organic phase exists as a phase that is non-communicating with the inorganic cement phase, such as separate areas.

48. A ceramic material according to claim 43, characterised in that the organic phase exists as a network or as separate areas in the inorganic cement phase.

49. A method of producing a ceramic material according to claim 43 which comprises an organic phase in the form of a polymer, characterised by the steps of:
adding a second part component, being a monomer selected from the group consisting of monomers of hydrophilic methacrylate type, HEMA, monomers having phosphate groups, alkenoids, monomers for carbopolymers, diols,
diacids, amino acids, to a powdered material, comprising a first part component selected from the same group of monomers, and
if necessary, initiating a polymerisation reaction between the first and second part components,
whereby the first and second part components together form an organic phase, in the form of a polymer.

50. A method of producing a ceramic material according to claim 49, characterised in that the second part component is included in a hydration liquid, or added separately.

51. A method of producing a ceramic material according to claim 49, characterised in that the polymer is formed by co-polymerisation in situ.

52. A method of producing a ceramic material according to claim 49, characterised in that the polymer is formed by condensation polymerisation in situ. 53. A method according to claim 49, characterised in that the polymerisation reaction is initiated when the first and second components are brought in contact.

54. A method according to claim 49, characterised in that the polymerisation reaction is photo- or thermochemically initiated.

55. A method according to claim 49, characterised in the hydration and polymerisation reactions not being allowed to give a temperature exceeding 50° C., in the material, which temperature control is effected by bringing the organic phase to form a network or separate areas in the inorganic cement phase and/or allowing the organic phase to constitute no more than 50% by volume of the material.

56. A method according to claim 49, characterised in that said powdered material initially is compacted to a degree of compaction above 55%, where after it is finely divided into granules of powder particles, which granules exhibit a mean size of 30-250 μm.

57. A method according to claim 56, characterised in that said granules are mixed with up to 50% of non pre-compacted powdered material of the same cement-based system as the powdered material in the granules.

58. A method according to claim 56, characterised in that the material is compacted to a raw compact that exhibits an average degree of compaction above 55%.

59. A method according to claim 57, characterised in that the material is suspended in a liquid that reacts with the binder phase, where after the resulting suspension/paste is drained and compacted before the material is allowed to harden by reaction between the binder phase and any liquid remaining, which compaction is done to a degree of compaction above 55%.

60. A method according to claim 57, characterised in that a hydration liquid is mixed with the granules by rolling, kneading or hand pressing such that a paste is formed, which paste is applied in a designated void.

61. A method according to claim 60, characterised in that the paste is applied by packing or squirting into the void.

62. A kit or system for producing a chemically bonded ceramic material, characterised in that it comprises a powdered material according to claim 33 and a hydration liquid a second part component which has the ability, together with a first part component comprised in said powdered material, to form an organic phase in the form of a polymer, and optionally an initiator for initiating the reaction between the first and second part components.

63. A device (10, 20) for storing and mixing of a powdered material and a hydration liquid, characterised in that said device comprises a first chamber (1) that holds a powdered material according to claim 33, and a second chamber (2) that holds a hydration liquid a second part component which has the ability, together with a first part component comprised in said powdered material, to form an organic phase in the form of a polymer, and an openable seal (3, 6) between the chambers (1, 2). 64. A device according to claim 63, characterised in that there is a greater pressure in the second chamber (2) than in the first chamber (1).

65. A device according to any claim 63, characterised in that at least the first chamber (1) has walls (4) of a wall material that is flexible enough for allowing processing of the powdered material through the walls (4).

66. A device according to claim 63, characterised in that the second chamber (2) is arranged inside the first chamber (1) comprises a ball (7), which second chamber and ball are formed such that, upon shaking of the device, the ball has the ability to break the walls of the second chamber and bring the first and second chamber into contact.
